(19) United States
(12) Patent Application Publication
(10) Pub. No.: US 2026/0011243 A1
(43) Pub. Date: Jan. 8, 2026

(54) SYSTEMS AND METHODS FOR FIXED ROUTE BUS SPEEDS FOR A FLEET OF BUSES

(71) Applicant: VIA TRANSPORTATION, INC., New York, NY (US)

(72) Inventors: Santiago TOSO, Barcelona (ES); Mattijs DE PAEPE, London (GB); Saar GOLDE, Forest Hills, NY (US); Tobias BARTSCH, Mamaroneck, NY (US)

(73) Assignee: VIA TRANSPORTATION, INC., New York, NY (US)

(21) Appl. No.: 19/258,054

(22) Filed: Jul. 2, 2025

Related U.S. Application Data
(60) Provisional application No. 63/667,256, filed on Jul. 3, 2024.

(51) Int. Cl. G08G 1/133; G06N 5/04; G06N 20/00

(52) U.S. Cl. CPC G08G 1/133; G06N 5/04; G06N 20/00

(57) ABSTRACT

A system and method for predicting fixed route travel time (e.g., bus speeds along bus routes) is provided. The system and method include a first machine learning model trained to predict speed along the fixed route without turning and dwell times. The speed from the first machine learning model, along with dwell time and turn time can be used with a second machine learning model to determine the overall route time.

### CROSS REFERENCE TO RELATED APPLICATIONS

This application claims the benefit of and priority to U.S. Provisional Patent Application No. 63/667,256, filed Jul. 3, 2024, the entire contents of which are owned by the assignee of the instant application and incorporated herein by reference in their entirety.

### FIELD OF THE INVENTION

The invention relates generally to buses/vehicle ridesharing and systems and methods for bus management.

### BACKGROUND OF THE INVENTION

Public transportation planning, particularly for bus services, can be a vital aspect of urban development. Accurate estimation of bus-running times can be important for schedule generation and/or for efficient budgeting during route planning. However, conventional methods, e.g., querying car-driving durations from online map tools, often fail to account for bus stop durations and for unique factors that can affect bus speeds.

Therefore, it can be desirable to accurately predict bus running times for new and/or modified bus routes.

### SUMMARY

Advantage of the invention can include accurately predicting bus running times for new and/or modified bus routes. Advantage of the invention can also include causing an autonomous bus to redirect based on a modified bus route. Advantage of the invention can also include modifying bus routes in real-time in response to an unplanned event (e.g., crash on a route or other event causing an obstruction).

In one aspect, the invention includes system for managing fixed route bus speeds for a fleet of buses. The system includes a communications interface configured to receive location data from the fleet of buses. The system includes at least one processor configured to in a training phase: i) receive a road network for the fleet of buses and historical location data of the fleet of buses on the road network; ii) determine edges based on the road network; iii) for each historical location in the historical location data, determine if it is accurate, and for an inaccurate historical location reset to a most likely edge; iv) filtering the historical location data to exclude locations that indicate bus dwelling or bus turning; v) train a first machine learning model to predict speed of buses based on features of the edges and features of the filtered historical location data; vi) using the first machine learning model to predict speed for each edge of each bus route in the historical location data; and vii) train a second machine learning model to predict total trip duration of buses based on the predicted speed for each edge, number of bus stops and corresponding bus stop location and at least some intersections and corresponding intersection locations. The at least one processor is also configured to in an inference phase i) receive a request for trip duration for a particular bus route at a particular time; ii) determine a sequence of edges based on the particular bus route; iii) apply the first machine learning model to each edge of the sequence of edges to predict speed of a bus along each edge of the particular bus route; iv) apply the second machine learning model to the speeds predicted of the edges, a number of bus stops of the particular bus route and corresponding location and time, and a number of intersections of the particular bus route and corresponding locations, to predict total trip duration of the bus; and v) transmit, to the communication interface, the route to a particular bus.

In some embodiments, using the first machine learning model to predict speed for each edge of each bus route in the historical GPS location data further comprises filtering out each bus route that is incomplete. In some embodiments, at least some interactions include an intersection where a right turn occurs, an intersection where a left turn occurs, and intersection where no turn occurs, or any combination thereof.

In some embodiments, in the inference phase, the second machine learning model further predicts bus dwell time for the particular bus route, bus turn time for the particular rout or any combination thereof.

In some embodiments, apply the second machine learning model further comprises determine bus turn time based on i) a number of right turns and an average turn time for right turns, ii) a number of left turns, an average turn time for left turns, iii) a number of pass through intersections and average number of pass through intersections, or any combination of i), ii), or iii).

In some embodiments, apply the second machine learning model further comprises determine a bus dwell time by determine a plurality of sections of a geographical area associated with the road network and for each section of the plurality of sections, determine an average dwell time based on all stops that lie within the respective section for a particular hour and a particular day type.

In some embodiments, the plurality of sections are hexagonal grid. In some embodiments, determine the features of the filtered historical data comprises determine a plurality of speeds, wherein each speed is between each successive location in the filtered historical location data, batch the plurality of speeds based on a predetermined time period, and determine a plurality of modes, each mode for each batched plurality of speeds.

In some embodiments, determine if the respective location is accurate further comprises determine whether the respective location in proper order along the route, and determine whether the respective location is on a road segment.

In another aspect, the invention involves a method for managing fixed route bus speeds for a fleet of buses. The method involves in a training phase, i) receiving a road network for the fleet of buses and historical location data of the fleet of buses on the road network; ii) determining edges based on the road network; iii) for each historical location in the historical location data, determining if it is accurate, and for an inaccurate historical location reset to a most likely edge; iv) filtering the historical location data to exclude locations that indicate bus dwelling or bus turning; v) training a first machine learning model to predict speed of buses based on features of the edges and features of the filtered historical location data; vi) using the first machine learning model to predict speed for each edge of each bus route in the historical location data; and vi) training a second machine learning model to predict total trip duration of buses based on the predicted speed for each edge, number of bus stops and corresponding bus stop location and at least some intersections and corresponding intersection locations. The method also involves in an inference phase, i) receiving a request for trip duration for a particular bus route at a particular time; ii) determining a sequence of edges based on the particular bus route; iii) applying the first machine learning model to each edge of the sequence of edges to predict speed of a bus along each edge of the particular bus route; iv) applying the second machine learning model to the speeds predicted of the edges, a number of bus stops of the particular bus route and corresponding location and time, and a number of intersections of the particular bus route and corresponding locations, to predict total trip duration of the bus; and v) transmitting, to the communication interface, the route to a particular bus.

In some embodiments, using the first machine learning model to predict speed for each edge of each bus route in the historical GPS location data further comprises filtering out each bus route that is incomplete. In some embodiments, at least some interactions include an intersection where a right turn occurs, an intersection where a left turn occurs, and intersection where no turn occurs, or any combination thereof.

In some embodiments, in the inference phase, the second machine learning model further predicts bus dwell time for the particular bus route, bus turn time for the particular rout or any combination thereof.

In some embodiments, applying the second machine learning model further comprises determining bus turn time based on i) a number of right turns and an average turn time for right turns, ii) a number of left turns, an average turn time for left turns, iii) a number of pass through intersections and average number of pass through intersections, or any combination of i), ii), or iii).

In some embodiments, applying the second machine learning model further comprises determining a bus dwell time by determining a plurality of sections of a geographical area associated with the road network and for each section of the plurality of sections, determining an average dwell time based on all stops that lie within the respective section for a particular hour and a particular day type.

In some embodiments, the plurality of sections are hexagonal grid. In some embodiments, determining the features of the filtered historical data further comprises determining a plurality of speeds, wherein each speed is between each successive location in the filtered historical location data, batching the plurality of speeds based on a predetermined time period, and determining a plurality of modes, each mode for each batched plurality of speeds.

In some embodiments, determining if the respective location is accurate further comprises determining whether the respective location in proper order along the route and determining whether the respective location is on a road segment.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, can be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 is a diagram of a ridesharing management system, according to some embodiments of the invention.

FIG. 2 is a diagram of a mobile communications device associated with a ridesharing management system, according to some embodiments of the invention.

FIG. 3 is a diagram of an automated ridesharing dispatch system, including ridesharing management server associated with a ridesharing management system, according to some embodiments of the invention.

FIG. 4 is a flow chart for a method for training a first machine learning model and a second machine learning model, according to some embodiments of the invention.

FIG. 5A is an example showing a bus route having a plurality of edges and historical location data, according to some embodiments of the invention.

FIG. 5B is an example of the bus route of FIG. 5A, including a bus stop, according to some embodiments of the invention.

FIG. 6 shows an example of encoding edges as sets of h3 cells according to some embodiments of the invention.

FIG. 7 is a flow chart for a method of determining bus routes, according to some embodiments of the invention.

FIG. 8 is an example of output showing a route for each of a plurality of bus stops as determined by the foregoing methods and system, according to some embodiments of the invention.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, and components, modules, units and/or circuits have not been described in detail so as not to obscure the invention.

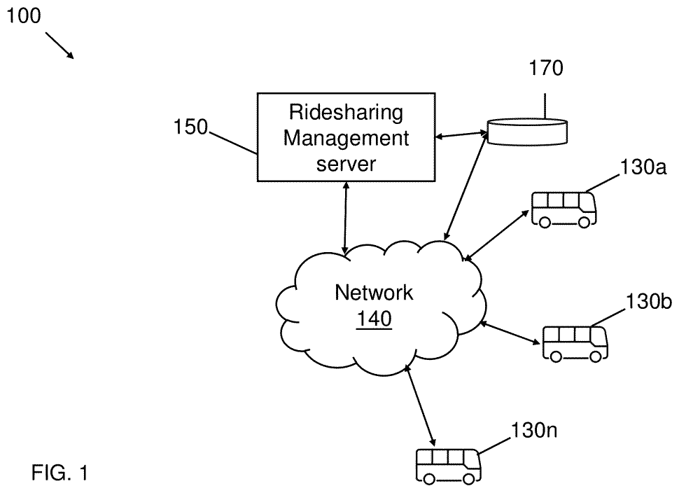

FIG. 1 is a diagram of a ridesharing management system 100, according to some embodiments of the invention. The ridesharing management system 100 includes a network 140, a ridesharing management server 150, a database 170, and a plurality of buses, 130a, 130b, . . . 130n, generally 130.

The network 140 can be coupled to the plurality of buses 130 to facilitate communications between the plurality of buses 130 and the ridesharing management server 150. As is apparent to one of ordinary skill in the art, the plurality of buses can each include communication interfaces, processors and/or mobile devices to receive and/or transmit data. The communication interfaces and/or processors can cause a route to be displayed to a driver of each respective plurality of buses 130 and/or in the case of an autonomous bus, cause the autonomous bus to follow a received route.

The network 140 can be any type of network that provides communications, exchanges information, and/or facilitates the exchange of information between ridesharing management server 150 and the plurality of buses 120. For example, network 140 can be the Internet, a Local Area Network, a cellular network, a public switched telephone network (“PSTN”), and/or other suitable connection(s) that enables ridesharing management system 100 to send and/or receive information between the components of the ridesharing management system 100. The network 140 can be wired and/or wireless depending on the type of connection to the network 140. Although the network 140 is shown herein as a cloud, the network 140 can include a variety of computing components, including wired and wireless components that in various networked configurations to facilitate desired communication between components.

The network 140 can support a variety of messaging formats as is known in the art, and may support a variety of services and applications for the plurality of buses 130. For example, the network 140 can support navigation services for plurality of buses 130, such as directing each bus to follow routes provided.

The ridesharing management server 150 can be a system that communicates with and/or is part of a communication service provider which provides a variety of data or services, such as voice, messaging, real-time audio/video, to the plurality of buses 130. The ridesharing management server 150 can be a computer-based system including computer system components, desktop computers, workstations, tablets, handheld mobile communications devices, memory devices, and/or internal network(s) connecting the components.

The ridesharing management server 150 can receive information from the plurality of buses 130 over the network 140, process the information, store the information, and/or transmit to the database 170. The ridesharing management server 150 can receive notifications regarding location data for the plurality of buses 130. The location data can be from GPS, Galileo or other location data sources in communication with the plurality of buses 130.

In various embodiments, cars, vans, SUVs, trucks and/or other vehicles suitable for human transportation are used in the ridesharing management system 100. In various embodiments, any vehicle suitable for human transport is schedule along a fixed route according to the foregoing embodiments. Any combination of vehicles can be used.

The database 170 may include one or more physical and/or virtual storages coupled with the ridesharing management server 150. The database 170 can store historical route data for one or more routes for the buses.

The historical route data can be input for a particular geographical region (e.g., a town having a plurality of bus routes). The historical route data can be provided by a municipality and/or any user desiring automatic bus route determination and/or automatically controlling autonomous buses.

The database 170 may include traffic data, maps, and/or toll road information. The traffic data may include historical traffic data and/or real-time traffic data regarding a certain geographical region. The traffic data may be used to determine traffic conditions.

The maps may include map information (e.g., roads, streets and/or distances) typically used for navigation purposes. The map information can be used to determine potential routes. The routes can be modified in transit, e.g., due to a driver driving off the route, events on the routes that prevent access to roads of the routes.

The data stored in database 170 can be transmitted to the ridesharing management server 150 for accommodating ride requests. In some embodiments, the database 170 is stored in a cloud-based server (not shown) that is accessible by the ridesharing management server 150 through the network 140. In some embodiments, the database 170 resides within the ridesharing management server 150.

In various embodiments, the ridesharing management server 150 is implemented on a single server or on multiple servers. Each server can be on a single computing device or distributed among multiple computing devices. In various embodiments, the ridesharing management system 100 includes multiple ridesharing management servers, and each ridesharing management server can serve a category of ridesharing services, ridesharing services associated with a certain category of service vehicles, and/or ridesharing services in a specific geographical region. For example, a first ridesharing management server can direct a first fleet of buses, a second ridesharing management server can direct a second fleet of buses and a third ridesharing server can direct a third fleet of buses. The first, second and third fleet of vehicles can be on-demand services, fixed-route services, or any combination thereof.

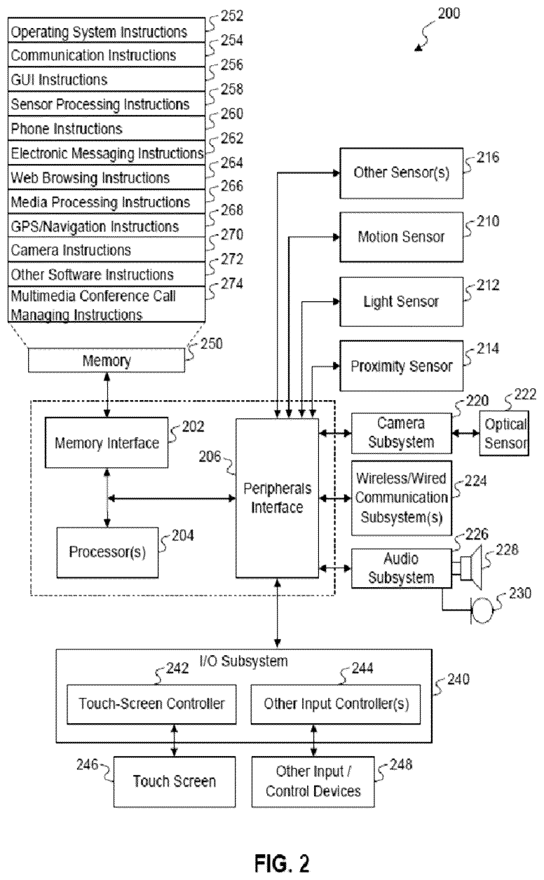

FIG. 2 is a diagram of a mobile communications device 200 (e.g., user device 120 100 as shown above in FIG. 1) associated with a ridesharing management system (e.g., ridesharing management system 100 as shown above in FIG. 1), according to some embodiments of the invention. The mobile communications device 200 can be in the plurality of buses (or any vehicle of the ridesharing management system) and can be used to implement computer programs, applications, methods, processes, or other software to perform embodiments of the invention described in herein. For example, turning back to FIG. 1, the plurality of buses 130 may respectively be installed with a ridesharing application.

Turning back to FIG. 2, the mobile communications device 200 can include a memory interface 202, one or more processors 204 such as data processors, image processors and/or central processing units, and/or a peripherals interface 206. The Memory interface 202, one or more processors 204, and/or peripherals interface 206 can be separate components or can be integrated in one or more integrated circuits. The various components in mobile communications device 200 may be coupled by one or more communication buses or signal lines.

Sensors, devices, and subsystems can be coupled to peripherals interface 206 to facilitate multiple functionalities. For example, a motion sensor 210, a light sensor 212, and a proximity sensor 214 may be coupled to peripherals interface 206 to facilitate orientation, lighting, and/or proximity functions. One or more sensors 216 can be connected to peripherals interface 206, such as a positioning system (e.g., GPS receiver), a temperature sensor, a biometric sensor, and/or other sensing devices. A GPS receiver can be integrated with, or connected to, mobile communications device 200. For example, a GPS receiver may be included in mobile telephones, such as smartphone devices. GPS software can allow mobile telephones to use an internal and/or external GPS receiver (e.g., connecting via a serial port or Bluetooth). The GPS can be used to obtain location data of the plurality of buses that can be transmitted to the ridesharing management system

Communication functions can be facilitated through one or more wireless/wired communication subsystems 224, which can include an Ethernet port, radio frequency receivers and transmitters and/or optical (e.g., infrared) receivers and/or transmitters. The specific design and implementation of wireless/wired communication subsystem 224 may depend on the communication network(s) over which mobile communications device 200 is intended to operate. For example, in some embodiments, mobile communications device 200 may include wireless/wired communication subsystems 224 designed to operate over a GSM network, a GPRS network, an EDGE network, a Wi-Fi or WiMax network, and a Bluetooth® network.

An audio subsystem 226 may be coupled to a speaker 228 and a microphone 230 to facilitate voice-enabled functions, such as voice recognition, voice replication, digital recording, and/or telephony functions.

I/O subsystem 240 may include touch screen controller 242 and/or other input controller(s) 244. Touch screen controller 242 may be coupled to touch screen 246. Touch screen 246 and touch screen controller 242 may, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch screen 246. While touch screen 246 is shown in FIG. 2, I/O subsystem 240 may include a display screen (e.g., CRT or LCD) in place of touch screen 246.

Other input controller(s) 244 may be coupled to other input/control devices 248, such as one or more buttons, rocker switches, thumb-wheel, infrared port, USB port, and/or a pointer device such as a stylus. Touch screen 246 may, for example, also be used to implement virtual or soft buttons and/or a keyboard.

Memory interface 202 may be coupled to memory 250. Memory 250 includes high-speed random access memory and/or non-volatile memory, such as one or more magnetic disk storage devices, one or more optical storage devices, and/or flash memory (e.g., NAND, NOR). Memory 250 may store an operating system 252, such as DRAWIN, RTXC, LINUX, iOS, UNIX, OS X, WINDOWS, or an embedded operating system such as VXWorkS. Operating system 252 may include instructions for handling basic system services and for performing hardware dependent tasks. In some implementations, operating system 252 can be a kernel (e.g., UNIX kernel).

Memory 250 may also store communication instructions 254 to facilitate communicating with one or more additional devices, one or more computers and/or one or more servers. Memory 250 can include graphical user interface instructions 256 to facilitate graphic user interface processing; sensor processing instructions 258 to facilitate sensor-related processing and functions; phone instructions 260 to facilitate phone-related processes and functions; electronic messaging instructions 262 to facilitate electronic-messaging related processes and functions; web browsing instructions 264 to facilitate web browsing-related processes and functions; media processing instructions 266 to facilitate media processing-related processes and functions; GPS/navigation instructions 268 to facilitate GPS and navigation-related processes and instructions; camera instructions 270 to facilitate camera-related processes and functions; and/or other software instructions 272 to facilitate other processes and functions.

In some embodiments, communication instructions 254 may include software applications to facilitate connection with ridesharing management server (e.g., ridesharing management server 150 as described above in FIG. 1) that handles bus route requests and/or an indication that the current route is obstructed. Graphical user interface instructions 256 may include a software program that facilitates a user associated with the mobile communications device to receive messages from ridesharing management server 150, provide user input, and so on.

Each of the above identified instructions and applications may correspond to a set of instructions for performing one or more functions described above. These instructions need not be implemented as separate software programs, procedures, or modules. Memory 250 may include additional instructions or fewer instructions. Furthermore, various functions of mobile communications device 200 may be implemented in hardware and/or in software, including in one or more signal processing and/or application specific integrated circuits.

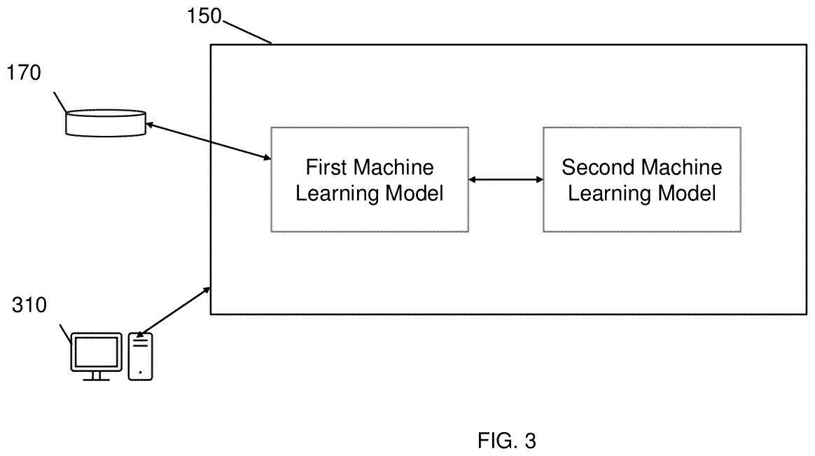

FIG. 3 is an example of a system for managing fixed route bus speeds for a fleet of buses, according to some embodiments. The system can include the ridesharing management server 150, the database 170, and/or a user 310. The ridesharing management server 150 can include a first machine learning model 320 and a second machine learning model 330.

The first machine learning model 320 and a second machine learning model 330 can be trained. The training can be based on historical location data for buses and bus routes in a particular defined geographical area. For example, a municipality may have several bus routes and collect bus location, stop and/or duration data for the bus routes in a particular geographic area. The training can involve training the first machine learning model 320 to predict speed of buses, and the second machine learning model 330 can be trained to predict total bus duration. In this manner, the prediction of total bus duration can be decomposed such that a more accurate prediction can be made.

During operation, the user 310 can request a bus duration for a route from a first location to a second location including a set of bus stops between the first location and the second location. The first machine learning model 320 and the second machine learning model 330 can be used to determine the duration. The second machine learning model 330 can also predict a dwell time for the desired route and/or a turn time for the desired route, as described in further detail below.

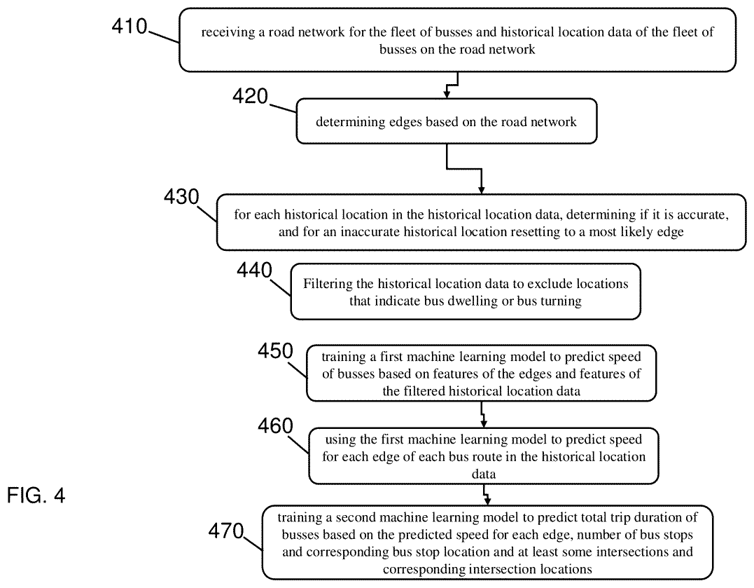

FIG. 4 is a flow chart for a method for training a first machine learning model and a second machine learning model, according to some embodiments of the invention.

The method can involve receiving a road network for the fleet of buses and historical location data of the fleet of buses on the road network (Step 410). The road network and historical location data can be input by a user (e.g., from a municipality, city, or any area having bus routes and desiring bus route prediction). The historical location data can include bus route data. The bus route data can include a bus start location and time, bus stop location and time, day of week, stops made along the way of the route and/or total duration that bus was stopped. In some embodiments, traffic pattern data and/or season of year are included in the historical location data. In some embodiments, the traffic pattern data and/or season of year are determined based on the historical location data. In some embodiments, the historical location data is based on a device in each bus. For example, a bus having a GPS can provide GPS data, a bus having Galileo can provide Galileo data. The historical location data can be collected from any satellite system as is known in the art.

The historical location data can be based on bus location in latitude and longitude at a particular time. The historical location data can be acquired from real time data feeds (e.g., VehiclePositions feed in GTFS Realtime (GTFS-RT)), or inferred from the TripUpdates feed that is part of GTFS-RT).

The historical location data can be for a single month of one year, and/or maintain separate models for different seasons of the year. In some embodiments, the historical location data can be limited to a particular season-of-year. In some embodiments, the historical location data can be one year's worth of data

The method can involve determining edges based on the road network (Step 420). The edges can be determined from a map of the geographical area of the road network. The edges can belong to road classes (e.g., highway, residential road, bicycle path, etc.). In some embodiments, other road characteristics such as the number of lanes, the edge's cardinal direction, the longitude and latitude of the edge's head can be collected as features and associated with their respective edge.

For each historical location in the historical location data, determining if it is accurate, and for an inaccurate historical location reset to a most likely edge (Step 430). The historical location data can be noisy. For example, data from a moving bus can be recorded at a location that is not realistic (e.g., inside of a building) and/or not make sense (e.g., an intermediate data point that is impossible for the bus to travel). The historical location data can be reset to a most likely location. For example, for a route that is travelling along a particular road, if a location is out of sequence, the location can be returned to the sequence or discarded. In another example, correcting the determined edges can involve using a snapping algorithm as is known in the art.

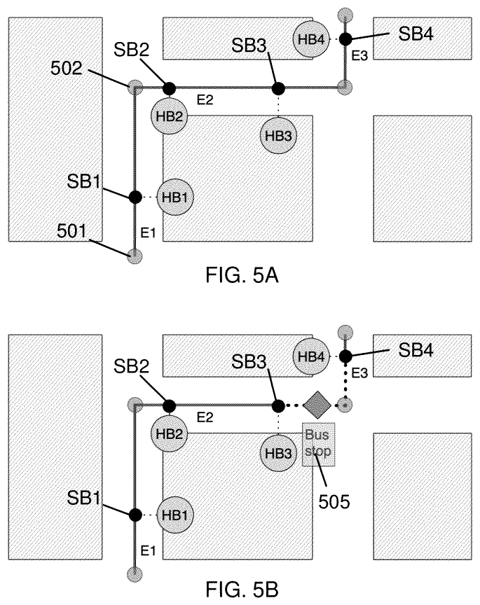

Turning to FIG. 5A, FIG. 5A is an example showing a bus route having a plurality of edges, E1, E2, and E3, and historical location data (e.g., heartbeat data from the bus along the route) at HB1, HB2, HB3, and HB4. HB1, HB2, and HB3, are noisy positions, as is shown, as they are not located on the edges but instead near the edges. The corresponding dot, SB1, SB2, SB3, and SB4 are the accurate locations (e.g., snapped back locations). The speed can be determined between a beginning and ending of each edge. For example, in FIG. 5A, edge E1 has start 501 and end 502. Each edge can have one heartbeat, e.g., E1 has heartbeat HB1. In some embodiments, if there are more than one heartbeat on each edge, the speed can be determined by determining the speed for the last heartbeat between the beginning and end of the edges. Edge E2 is an example of an edge with two heartbeats, HB2 and HB3, such that the speed based on HB1-HB2, HB2-HB3 and HB3-HB4 can be relevant, but only HB3-HB4 of these speeds is retained. Each edge with its corresponding speed can be added to the training data.

In some embodiments, more historical location data is captured along each edge (e.g., two data points, three data points). As is apparent to one of ordinary skill in the art, FIG. 5 shows only a portion of one bus route and that the historical location data can include many more routes and location data.

Turning back to FIG. 4, the method can involve filtering the historical location data to exclude locations that indicate bus dwelling or bus turning (Step 440). For example, bus dwelling can be indicated at a location that is a bus stop. Bus turning can be indicated at a location that is an intersection and where the edges indicate a turn happened.

Turning to FIG. 5B, FIG. 5B is an example of the bus route of FIG. 5A, including a bus stop 505. The two adjacent snapped heartbeats, SB2 and SB3, can be used to determine speed for E2 and not SB3-SB4 as the bus stop is between them.

Turning back to FIG. 4, the method can involve training a first machine learning model to predict speed of buses based on features of the edges and features of the filtered historical location data (Step 450).

The first machine learning model can be supervised learning.

The method can involve using the first machine learning model to predict speed for each edge of each bus route in the historical location data (Step 460). In the historical location data, each time a bus traversed an edge, its speed can be computed. In some embodiments, the historical location data is captured at a frequency that is high enough such that the speed computed from adjacent data points can be mapped to one or a few (e.g., 2-4) edges.

The first machine learning model can predict the speed along each edge based on a driving time along edges. The first machine learning model can predict the speed along each edge on a bus route by bus route basis, in accordance with the historical location data. For example, assume the historical location data has twenty bus routes, edges can be determined for each bus route (e.g., in accordance with Step 420 above), and the bus route edges can be used to determine the speed along each edge in each route, such that predicted speed of a first bus route of the twenty is determined, and a second bus route of the twenty is determined, and so forth. The bus route speeds can be determined without the turn time and dwell time, as indicated by the filtering.

The first machine learning model can be trained to predict bus speed vᵢ on each edge instance i as shown below in EQN. 1:

$${v}_{i} = f ( {X}_{i} ) \qquad EQN . 1$$

where ƒ(Xᵢ) is a non-linear function and Xᵢ is a feature vector of edge instance i. Each feature vector can include a location and time of week.

In some embodiments, the first machine learning model can take as input car-traffic patterns. The car-traffic patterns can be directly input to the first machine learning model or can be input as proxy features. The proxy features can include location of each edge as a feature, the time-of-day and day-type. Each location (e.g., each lat/long pair) can be encoded as a set of ids of h3 cells (e.g., resolutions 5 to 8) to which a start of an edge belongs. In this manner the first machine model can be trained to learn about spatial relationships at different length scales.

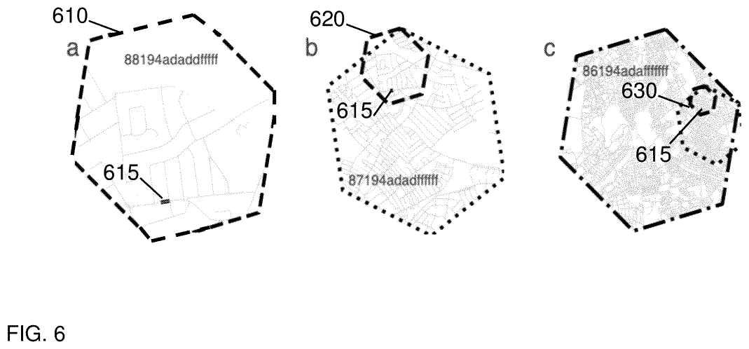

Tuning to FIG. 6, FIG. 6 shows an example of encoding edges as sets of h3 cells according to some embodiments. As shown in h3 cell 610 an edge 615 is shown along an example residential street (e.g., a residential street in a geographical area of London). The edge 615 can be assigned to a unique h3 cell 620 of resolution 8 with an h3-cell id of 88194adaddfffff. The edge 615 can also be assigned to a h3 cell of resolution 7 with the h3-cell id 87194adadffffff. The edge 615 can also be assigned to a h3 cell of resolution 6 with the h3-cell id of 86194adafffffff. Having h3-cell ids as categorical features can allow the first machine learning model to learn how bus speeds can depend on the short, medium and/or long range surroundings of each edge. Short, medium and/or long range can be based on average edge lengths of the h3-cells (e.g., res 6: 3.7 km; res 7: 1.4 km; and/or res 8: 0.5 km).

For a particular geographical region, many h3 cells can exist without existing bus routes (e.g., without training data). The h3-cell ids have less than a threshold number of observations (e.g., data in the historical location data) can be labeled with an “infrequent” category. The infrequent category can be used during inference for a request for predictions in an h3 cell that was not present in the training data.

In various embodiments, shapes other than hexagonal shapes are used. For example, instead of an h3 grid a rectangle, square or any shape grid (e.g., S2 geometry).

The function ƒ as shown above in EQN. 1 can be represented as a random forest, with its hyper parameters tuned by 2-fold cross validation on the training set.

Turning back to FIG. 4, in some embodiments, features for the bus speed model can be as shown below in Table 1.

TABLE 1

| | cardinal dir | road class | hour | day type | h3 res5 | h3 res6 | h3 res7 | h3 res8 |
|---|---|---|---|---|---|---|---|---|
| 0 | SW | service/other | 10 | Weekday | 85194adbfffffff | 86194adafffffff | 87194adabffffff | 88194adabdfffff |
| 1 | W | secondary | 10 | Workday | 85194ad3fffffff | 86194e69fffffff | 87194e69bffffff | 88194e69b1fffff |
| 2 | W | secondary | 10 | Weekday | 85194ad3fffffff | 86194e69fffffff | 87194e69bffffff | 88194e69b1fffff |
| 3 | W | secondary | 10 | Weekday | 85194ad3fffffff | 86194e69fffffff | 87194e69bffffff | 88194e69b1fffff |
| 4 | E | unclassified | 10 | Weekday | 85195da7fffffff | 86195da47ffffff | 87195da42ffffff | 88195da423fffff |
| 5 | E | residential | 10 | Weekday | 85194ac3fffffff | 86194ac17ffffff | 87194ac13ffffff | 88194ac13bfffff |
| 6 | E | residential | 10 | Weekday | 85194ac3fffffff | 86194ac17ffffff | 87194ac11ffffff | 88194ac13bfffff |
| 7 | NW | unclassified | 10 | Workday | 85194acffffffff | 86194acc7ffffff | 87194acc4ffffff | 88194acc4dfffff |
| 8 | SW | unclassified | 10 | Weekday | 85194acffffffff | 86194acc7ffffff | 87194acc4ffffff | 88194acc4dfffff |
| 9 | SE | residential | 10 | Weekday | 85194e6bfffffff | 86194e69fffffff | 87194e69cffffff | 88194e69c1fffff |

The method can also involve training a second machine learning model to predict total trip duration of buses based on the predicted speed for each edge, number of bus stops and corresponding bus stop location and at least some intersections and corresponding intersection locations (Step 470). The historical location data and edges can be used by the first machine learning model to predict the speed for each edge. The speed for each edge as predicted by the first machine learning model can be used to train the second machine learning model. In other words, the first machine learning model can contribute to the data that trains the second machine learning model.

The number of bus stops and corresponding bus stop location can be used to train the second machine learning model such that a coefficient for number of bus stops can be determined. The at least some intersections can be intersections where a right turn occurs, intersections where a left turn occurs, intersections where the bus passes through, or any combination thereof.

The second machine learning model can be trained to predict total bus running time for a route (e.g., trip) (Tₘ) as shown below in EQN. 2:

$${T}_{m} = {T}_{d riving , m} + {T}_{dwell , m} + {T}_{turn , m} \qquad EQN . 2$$

where T_{driving,m} is a total driving duration for the route, T_{dwell,m} is total dwell time for the bus during the route, and T_{turn,m} is a turn duration during the route.

The total driving duration for the route T_{driving,m} can be determined as shown below in EQN. 3:

$${T}_{d riving , m} = {\sum }_{j} Δ {x}_{j} / {v}_{j} \qquad EQN . 3$$

where Δxⱼ/vⱼ is the time spent on edge j over all edges in the route of trip m, Δxⱼ is the length of edge j traversed by trip instance m, and vⱼ is the speed as predicted by the first machine learning model for edge j.

The total dwell time T_{dwell,m} for the bus during the route can be determined as shown below in EQN. 4:

$${T}_{dwell , m} = {\sum }_{k ∈ stops along trip m} {D}_{Hex [ k ] , daytype , hour} \qquad EQN . 4$$

where Hex[k] is the resolution 6 h3 id containing the stop k, daytype is either “weekday” or “weekend”, and hour is the hour-of-day. D_{Hex[k],daytype,hour} describes the average dwelling of all dwell times in Hex[k] at stop k for hour on daytype.

The turn duration during the route T_{turn,m} can be determined as shown below in EQN. 5:

$${T}_{turn , m} = {n}_{m , r ight} \cdot {D}_{turn , right} + {n}_{m , left} \cdot {D}_{turn , left} \qquad EQN . 5$$

where n_{m,right} is number of right turns along the route m, D_{turn,right} is average time it takes to make a right turn along the route m, n_{m,left} is number of left turns, and D_{turn,left} is average time it takes to make a right turn along the route m. In this manner, an assumption that turning times do not substantially vary. In some embodiments, only right turns are used. In some embodiments, only left turns are used. In some embodiments, pass-through intersections are included. In some embodiments, only a subset of the turns/pass-throughs are used.

In this manner, the second machine learning model can be trained to predict total bus running time for a route, dwell time and/or turn time.

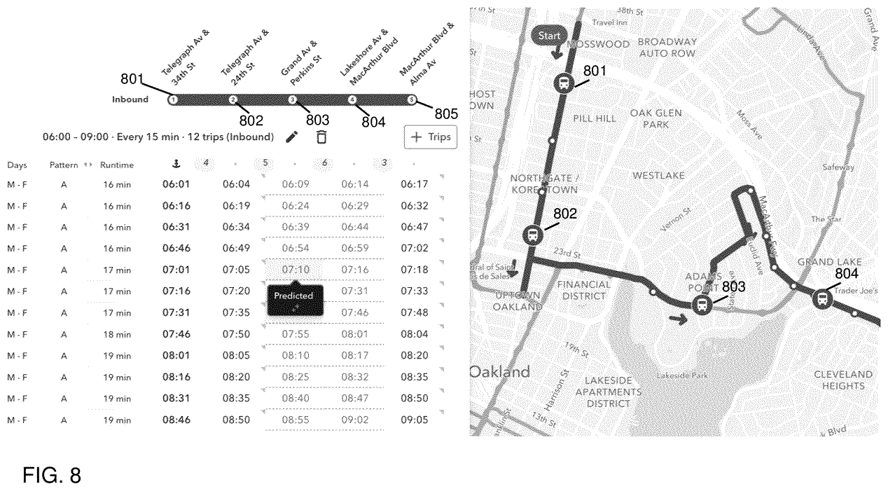

During inference, a new bus route can be created or a current bus route modified. The new bus route or the current bus route can be output as a timetable (e.g., as discussed in further detail below with respect to FIG. 8). In some embodiments, the new bus route or modified bus route is transmitted to a device of the bus. In some embodiments, the new bus route or modified bus route is transmitted to a device of the bus in real time, to redirect the bus to follow the new or modified bus timing mid-route. In some embodiments, the new bus route or modified bus route timing is sent to an autonomous bus, and causes the autonomous bus to automatically follow the new timing.

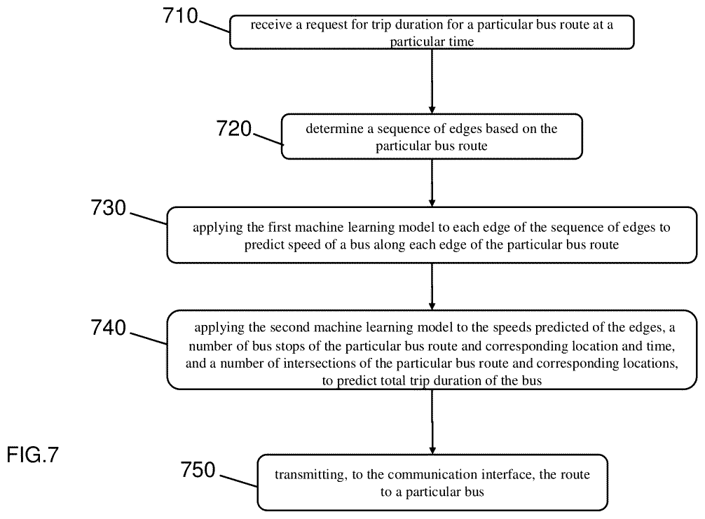

FIG. 7 is a flow chart for a method of determining bus routes, according to some embodiments of the invention.

In various embodiments, the systems and methods as described above are applied to any geographical areas having any fixed route system (e.g., vans servicing an area with fixed routes).

The method can involve receiving a request for trip duration for a particular bus route at a particular time (Step 710). The particular bus route can be in a geographical area that the first and second machine learning models are trained on. In some embodiments, the particular bus route can be within a predetermined distance of the geographical area that the first and second machine learning models are trained on. In some embodiments, the request can involve a request for dwell time and/or turn time.

The method can involve determining a sequence of edges based on the particular bus route (Step 720). For example, as described above.

The method can involve applying the first machine learning model to each edge of the sequence of edges to predict speed of a bus along each edge of the particular bus route (Step 730).

The method can involve applying the second machine learning model to the speeds predicted of the edges, a number of bus stops of the particular bus route and corresponding location and time, and a number of intersections of the particular bus route and corresponding locations, to predict total trip duration of the bus (Step 740). In some embodiments, the second machine learning can predict the dwell time and/or turn time.

The method can involve transmitting, to the communication interface, the route to a particular bus (Step 750). In some embodiments, the route is transmitted to a display of a bus route planner. In some embodiments, the route is transmitted to a display of the particular bus, or the particular bus is an autonomous bus and automatically follows the route.

FIG. 8 is an example of output showing a route for each of a plurality of bus stops as determined by the foregoing methods and system, according to some embodiments of the invention. The plurality of bus stops 801, 802, 803, 804 and 805. For the route, for a bus to arrive at each stop every 15 minutes, the route for each bus is shown. For example, at 6:01 a first bus can arrive at stop 801, 6:04 at stop 802, 6:09 at stop 803, 6:14 at stop 804 and at 6:17 stop 805. A second bus can arrive 15 minutes later, at 6:16 at stop 801. The second bus can continue along the route such that at 6:19 the second bus arrives at stop 802, 6:24 at stop 803, 6:29 at stop 804 and at 6:32 stop 805, and so forth.

One skilled in the art will realize the invention can be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

Although embodiments of the invention are not limited in this regard, the terms “plurality” and “a plurality” as used herein can include, for example, “multiple” or “two or more”. The terms “plurality” or “a plurality” can be used throughout the specification to describe two or more components, devices, elements, units, parameters, or the like. The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by an apparatus and can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implement that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device, a transmitting device, and/or a computing device. The display device can be, for example, a cathode ray tube (CRT) and/or a liquid crystal display (LCD) monitor. The interaction with a user can be, for example, a display of information to the user and a keyboard and a pointing device (e.g., a mouse or a trackball) by which the user can provide input to the computer (e.g., interact with a user interface element). Other kinds of devices can be used to provide for interaction with a user. Other devices can be, for example, feedback provided to the user in any form of sensory feedback (e.g., visual feedback, auditory feedback, or tactile feedback). Input from the user can be, for example, received in any form, including acoustic, speech, and/or tactile input.

The computing device can include, for example, a computer, a computer with a browser device, a telephone, an IP phone, a mobile device (e.g., cellular phone, personal digital assistant (PDA) device, laptop computer, electronic mail device), and/or other communication devices. The computing device can be, for example, one or more computer servers. The computer servers can be, for example, part of a server farm. The browser device includes, for example, a computer (e.g., desktop computer, laptop computer, and tablet) with a World Wide Web browser (e.g., Microsoft® Internet Explorer® available from Microsoft Corporation, Chrome available from Google, Mozilla® Firefox available from Mozilla Corporation, Safari available from Apple). The mobile computing device includes, for example, a personal digital assistant (PDA).

Website and/or web pages can be provided, for example, through a network (e.g., Internet) using a web server. The web server can be, for example, a computer with a server module (e.g., Microsoft® Internet Information Services available from Microsoft Corporation, Apache Web Server available from Apache Software Foundation, Apache Tomcat Web Server available from Apache Software Foundation).

The storage module can be, for example, a random access memory (RAM) module, a read only memory (ROM) module, a computer hard drive, a memory card (e.g., universal serial bus (USB) flash drive, a secure digital (SD) flash card), a floppy disk, and/or any other data storage device. Information stored on a storage module can be maintained, for example, in a database (e.g., relational database system, flat database system) and/or any other logical information storage mechanism.

The above-described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

The above described networks can be implemented in a packet-based network, a circuit-based network, and/or a combination of a packet-based network and a circuit-based network. Packet-based networks can include, for example, the Internet, a carrier internet protocol (IP) network (e.g., local area network (LAN), wide area network (WAN), campus area network (CAN), metropolitan area network (MAN), home area network (HAN), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, Bluetooth®, code-division multiple access (CDMA) network, time division multiple access (TDMA) network, global system for mobile communications (GSM) network), and/or other circuit-based networks.

Some embodiments of the present invention may be embodied in the form of a system, a method or a computer program product. Similarly, some embodiments may be embodied as hardware, software or a combination of both. Some embodiments may be embodied as a computer program product saved on one or more non-transitory computer readable medium (or media) in the form of computer readable program code embodied thereon. Such non-transitory computer readable medium may include instructions that when executed cause a processor to execute method steps in accordance with embodiments. In some embodiments the instructions stored on the computer readable medium may be in the form of an installed application and in the form of an installation package.

Such instructions may be, for example, loaded by one or more processors and get executed. For example, the computer readable medium may be a non-transitory computer readable storage medium. A non-transitory computer readable storage medium may be, for example, an electronic, optical, magnetic, electromagnetic, infrared, or semiconductor system, apparatus, or device, or any combination thereof.

Computer program code may be written in any suitable programming language. The program code may execute on a single computer system, or on a plurality of computer systems.

In the foregoing detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments.

1. A system for managing fixed route bus speeds for a fleet of buses, the system comprising:
a communications interface configured to receive location data from the fleet of buses;
at least one processor configured to:
in a training phase:
i) receive a road network for the fleet of buses and historical location data of the fleet of buses on the road network;
ii) determine edges based on the road network;
iii) for each historical location in the historical location data, determine if it is accurate, and for an inaccurate historical location reset to a most likely edge;
iv) filtering the historical location data to exclude locations that indicate bus dwelling or bus turning;
v) train a first machine learning model to predict speed of buses based on features of the edges and features of the filtered historical location data;
vi) using the first machine learning model to predict speed for each edge of each bus route in the historical location data;
vii) train a second machine learning model to predict total trip duration of buses based on the predicted speed for each edge, number of bus stops and corresponding bus stop location and at least some intersections and corresponding intersection locations;
in an inference phase:
viii) receive a request for trip duration for a particular bus route at a particular time;
ix) determine a sequence of edges based on the particular bus route;
x) apply the first machine learning model to each edge of the sequence of edges to predict speed of a bus along each edge of the particular bus route;
xi) apply the second machine learning model to the speeds predicted of the edges, a number of bus stops of the particular bus route and corresponding location and time, and a number of intersections of the particular bus route and corresponding locations, to predict total trip duration of the bus; and
xii) transmit, to the communication interface, the route to a particular bus.

2. The system of claim 1 wherein using the first machine learning model to predict speed for each edge of each bus route in the historical GPS location data further comprises filtering out each bus route that is incomplete.

3. The system of claim 1 wherein the at least some interactions include an intersection where a right turn occurs, an intersection where a left turn occurs, and intersection where no turn occurs, or any combination thereof.

4. The system of claim 1 wherein in the inference phase, the second machine learning model further predicts bus dwell time for the particular bus route, bus turn time for the particular rout or any combination thereof.

5. The system of claim 1 wherein apply the second machine learning model further comprises determine bus turn time based on i) a number of right turns and an average turn time for right turns, ii) a number of left turns, an average turn time for left turns, iii) a number of pass through intersections and average number of pass through intersections, or any combination of i), ii), or iii).

6. The system of claim 1 wherein apply the second machine learning model further comprises determining a bus dwell time by:
determine a plurality of sections of a geographical area associated with the road network; and
for each section of the plurality of sections, determine an average dwell time based on all stops that lie within the respective section for a particular hour and a particular day type.

7. The system of claim 6 wherein the plurality of sections are hexagonal grid.

8. The system of claim 1 wherein determine the features of the filtered historical data further comprises:
determine a plurality of speeds, wherein each speed is between each successive location in the filtered historical location data;
batch the plurality of speeds based on a predetermined time period; and
determine a plurality of modes, each mode for each batched plurality of speeds.

9. The system of claim 1 wherein determine if the respective location is accurate further comprises:
determine whether the respective location in proper order along the route; and
determine whether the respective location is on a road segment.

10. A method for managing fixed route bus speeds for a fleet of buses, the method comprising:
in a training phase:
i) receiving a road network for the fleet of buses and historical location data of the fleet of buses on the road network;
ii) determining edges based on the road network;
iii) for each historical location in the historical location data, determining if it is accurate, and for an inaccurate historical location reset to a most likely edge;
iv) filtering the historical location data to exclude locations that indicate bus dwelling or bus turning;
v) training a first machine learning model to predict speed of buses based on features of the edges and features of the filtered historical location data;
vi) using the first machine learning model to predict speed for each edge of each bus route in the historical location data;
vii) training a second machine learning model to predict total trip duration of buses based on the predicted speed for each edge, number of bus stops and corresponding bus stop location and at least some intersections and corresponding intersection locations;
in an inference phase:
viii) receiving a request for trip duration for a particular bus route at a particular time;
ix) determining a sequence of edges based on the particular bus route;
x) applying the first machine learning model to each edge of the sequence of edges to predict speed of a bus along each edge of the particular bus route;
xi) applying the second machine learning model to the speeds predicted of the edges, a number of bus stops of the particular bus route and corresponding location and time, and a number of intersections of the particular bus route and corresponding locations, to predict total trip duration of the bus; and
xii) transmitting, to the communication interface, the route to a particular bus.

11. The method of claim 10 wherein using the first machine learning model to predict speed for each edge of each bus route in the historical GPS location data further comprises filtering out each bus route that is incomplete.

12. The method of claim 10 wherein the at least some interactions include an intersection where a right turn occurs, an intersection where a left turn occurs, and intersection where no turn occurs, or any combination thereof.

13. The method of claim 10 wherein in the inference phase, the second machine learning model further predicts bus dwell time for the particular bus route, bus turn time for the particular rout or any combination thereof.

14. The method of claim 10 wherein applying the second machine learning model further comprises determining bus turn time based on i) a number of right turns and an average turn time for right turns, ii) a number of left turns, an average turn time for left turns, iii) a number of pass through intersections and average number of pass through intersections, or any combination of i), ii), or iii).

15. The method of claim 10 wherein applying the second machine learning model further comprises determining a bus dwell time by:
determining a plurality of sections of a geographical area associated with the road network; and
for each section of the plurality of sections, determining an average dwell time based on all stops that lie within the respective section for a particular hour and a particular day type.

16. The method of claim 15 wherein the plurality of sections are hexagonal grid.

17. The method of claim 10 wherein determining the features of the filtered historical data further comprises:
i) determine a plurality of speeds, wherein each speed is between each successive location in the filtered historical location data;
ii) batch the plurality of speeds based on a predetermined time period; and
iii) determine a plurality of modes, each mode for each batched plurality of speeds.

18. The method of claim 10 wherein determining if the respective location is accurate further comprises:
determining whether the respective location in proper order along the route; and
determining whether the respective location is on a road segment.
